(19) United States
(12) Patent Application Publication
(10) Pub. No.: US 2025/0389242 A1
(43) Pub. Date: Dec. 25, 2025

(54) INTAKE MANIFOLD AND INTAKE SYSTEM

(71) Applicant: MIKUNI CORPORATION, Tokyo (JP)

(72) Inventors: Takayuki HAYASHI, Kanagawa (JP); Natthavud Songprasert, Kanagawa (JP)

(73) Assignee: MIKUNI CORPORATION, Tokyo (JP)

(21) Appl. No.: 19/185,201

(22) Filed: Apr. 21, 2025

(30) Foreign Application Priority Data
Jun. 24, 2024 (JP) 2024-101410

(51) Int. Cl. F02M 35/104; F02M 61/14

(52) U.S. Cl. CPC F02M 35/104; F02M 61/14; F02M 2200/85

(57) ABSTRACT

An intake manifold made of resin applied to an engine includes: a surge tank that defines an internal space temporarily storing intake air, an inlet, and a flange part configured to fix a throttle body around the inlet; multiple branch pipes that are integrally molded with the surge tank and include tubular fitting parts at respective tip regions; and a linking part integrally molded with the multiple branch pipes to link the multiple branch pipes to each other upstream of the tubular fitting parts.

### CROSS-REFERENCE TO RELATED APPLICATION

This application claims the priority benefit of Japan application serial no. 2024-101410, filed on Jun. 24, 2024. The entirety of the above-mentioned patent application is hereby incorporated by reference herein and made a part of this specification.

### BACKGROUND

### Technical Field

The disclosure relates to an intake manifold and an intake system applied to an engine, and particularly to an intake manifold and an intake system connected by a spigot joint to a tubular part defining an intake port of an engine mounted on a vehicle that travels in rough road environments such as a recreational off-highway vehicle (ROV) and a utility task vehicle (UTV).

### Related Art

An intake system of an engine mounted on a snowmobile is known as a conventional intake system. Such an intake system includes: an intake manifold having one tubular linking part on the upstream side and three tubular linking parts on the downstream side, with a surge tank interposed therebetween; an intake pipe connected to the one tubular linking part on the upstream side; three rubber ducts connected to the three tubular linking parts on the downstream side; three throttle bodies connected to the downstream ends of the rubber ducts; three rubber joint members that link, by spigot joints, the throttle bodies with tubular linking parts leading to intake ports of an engine body; and vibration damping members that press down and link the three rubber ducts to the engine body (e.g., refer to Patent Document 1: Japanese Patent Application Laid-Open No. 2016-223355).

When assembling this intake system, it is required to connect the three rubber ducts to the intake manifold and fasten each of them with a band, connect the three throttle bodies to the three rubber ducts and fasten each of them with a band, connect the three throttle bodies to the tubular linking parts of the engine via the three rubber joint members, and engage the vibration damping members with the three rubber ducts and fix to the engine body. In other words, the conventional intake system has a complex structure, includes a large number of components, and involves a complicated assembling work, which leads to increased costs.

### SUMMARY

An intake manifold of an embodiment of the disclosure is made of resin applied to an engine, including: a surge tank that defines an internal space temporarily storing intake air, an inlet, and a flange part configured to fix a throttle body around the inlet; multiple branch pipes that are integrally molded with the surge tank and include tubular fitting parts at respective tip regions; and a linking part integrally molded with the multiple branch pipes to link the multiple branch pipes to each other upstream of the tubular fitting parts.

In the intake manifold according to an embodiment, upstream of the tubular fitting parts, the multiple branch pipes may include attachment parts to which fuel injection valves are to be respectively attached, and at least two fixing parts configured to fix a feed pipe that feeds fuel to the fuel injection valves.

In the intake manifold according to an embodiment, each of the fixing parts may be formed in a region of the linking part.

In the intake manifold according to an embodiment, the linking part may include a tip-side linking part formed close to a downstream side of the branch pipe, and an intermediate linking part formed in an intermediate region closer to an upstream side than the tip-side linking part.

In the intake manifold according to an embodiment, each of the fixing parts may be formed in a region of the intermediate linking part.

In the intake manifold according to an embodiment, the multiple branch pipes may each include a first reinforcement rib formed protruding from an outer wall from a branching region, branching from the surge tank, to an intermediate region.

In the intake manifold according to an embodiment, the surge tank may be formed to be elongated in a direction of a predetermined axis. The multiple branch pipes may be formed to extend in a direction twisted with respect to the axis and include a curved part that is curved in a plane perpendicular to the axis. The first reinforcement rib may be formed to have an outline that extends linearly from an outer wall of the surge tank to an outer wall of the branch pipe in a recess region surrounded by the curved part.

In the intake manifold according to an embodiment, the multiple branch pipes may include a second reinforcement rib that protrudes from the outer wall on a side opposite to a side formed with the recess region and downstream of the curved part, and extends from the vicinity of the tubular fitting part toward an upstream side.

In the intake manifold according to an embodiment, the surge tank may include a grid reinforcement rib integrally molded on an outer wall of the surge tank.

The intake manifold according to an embodiment may include: a first molding member defining a first half body of the surge tank and the multiple branch pipes, the tubular fitting parts, the inlet, and the flange part; and a second molding member defining a second half body of the surge tank and the multiple branch pipes and joined to the first molding member.

The intake manifold according to an embodiment may include: a first molding member defining a first half body of the surge tank and the multiple branch pipes, the tubular fitting parts, the inlet, and the flange part; and a second molding member defining a second half body of the surge tank and the multiple branch pipes and joined to the first molding member. The first molding member may include a first linking part forming a part of the linking part, the attachment parts, and the fixing parts, and the second molding member may include a second linking part forming a part of the linking part.

The intake manifold according to an embodiment may include: a first molding member defining a first half body of the surge tank and the multiple branch pipes, the tubular fitting parts, the inlet, and the flange part; and a second molding member defining a second half body of the surge tank and the multiple branch pipes and joined to the first molding member. The first molding member may include a first tip-side linking part forming a part of the tip-side linking part, a first intermediate linking part forming a part of the intermediate linking part, the attachment parts, and the fixing parts. The second molding member may include a second tip-side linking part forming a part of the tip-side linking part, and a second intermediate linking part forming a part of the intermediate linking part.

An intake system of an embodiment of the disclosure includes: the intake manifold with any the above configurations; fuel injection valves attached to the attachment parts; a feed pipe fixed to the fixing parts; and a throttle body fixed to the flange part.

The intake system according to an embodiment may include: a tubular joint member made of rubber, into one end side of which a tubular part defining an intake port of an engine fits and into another end side of which the tubular fitting part of the intake manifold fits.

The intake system according to an embodiment may include: a fastening band fastening around a fitting region of the tubular joint member.

The intake system according to an embodiment may include: an intake duct connected to the throttle body; and an air cleaner connected to an upstream end of the intake duct.

The intake system according to an embodiment may include: a support member supporting the intake duct or the air cleaner with respect to a vehicle body on which the engine is mounted.

According to the intake manifold and the intake system with the above configuration according to an embodiment, simplification of the structure, reduction in the number of components, simplification of the assembling work, cost reduction, etc. can be achieved while ensuring the mechanical strength.

### BRIEF DESCRIPTION OF THE DRAWINGS

FIG. 1 is a schematic view showing an intake system of an engine including an intake manifold according to an embodiment of the disclosure.

FIG. 2 is a partial view showing the intake manifold according to an embodiment and a part of the engine.

FIG. 3 is a partial cross-sectional view showing fastening bands and a tubular joint member connecting a tubular fitting part of the intake manifold according to an embodiment and a tubular part defining an intake port of the engine.

FIG. 4 is an external perspective view of the intake manifold according to an embodiment as viewed obliquely from above.

FIG. 5 is an external perspective view of the intake manifold according to an embodiment as viewed obliquely from below.

FIG. 6 is a side view of the intake manifold according to an embodiment as viewed from an inlet side.

FIG. 7 is an exploded perspective view of the intake manifold according to an embodiment, disassembled into a first molding member (base member) and a second molding member (cover member), as viewed obliquely from above.

FIG. 8 is an exploded perspective view of the intake manifold according to an embodiment, disassembled into the first molding member (base member) and the second molding member (cover member), as viewed obliquely from below.

FIG. 9 is a perspective view of the first molding member (base member) constituting the intake manifold according to an embodiment, as viewed from the inside.

FIG. 10 is a perspective view of the second molding member (cover member) constituting the intake manifold according to an embodiment, as viewed from the inside.

FIG. 11 is a cross-sectional view taken along a plane passing through approximately the center of a passage of one branch pipe in the intake manifold according to an embodiment.

FIG. 12 is a cross-sectional view taken along a plane passing between two branch pipes in the intake manifold according to an embodiment.

FIG. 13 is a perspective cross-sectional view showing three branch pipes as viewed from the upstream side with the surge tank cut away in the intake manifold according to an embodiment.

FIG. 14 is a perspective cross-sectional view taken along a plane crossing an intermediate linking part integrally molded with a fixing part between the branch pipes in the intake manifold according to an embodiment.

FIG. 15 is a cross-sectional view taken along a plane passing between two branch pipes in the intake manifold according to an embodiment.

FIG. 16 is a cross-sectional view taken along a plane crossing the intermediate linking part integrally formed with the fixing part between the branch pipes in the first molding member (base member) constituting the intake manifold according to an embodiment.

FIG. 17 is a cross-sectional view taken along the same plane as the cross-section shown in FIG. 16 in the second molding member (cover member) constituting the intake manifold according to an embodiment.

### DESCRIPTION OF THE EMBODIMENTS

Embodiments of the disclosure provide an intake manifold and an intake system that achieve simplification of the structure, reduction in the number of components, simplification of an assembling work, cost reduction, etc. while ensuring a mechanical strength.

Hereinafter, embodiments of the disclosure will be described with reference to the attached drawings. An intake manifold M according to the disclosure is molded using a resin material and constitutes a part of an intake system of an engine. Herein, as an embodiment, a case where the intake manifold M is applied to a three-cylinder engine E mounted on an ROV or a UTV will be described.

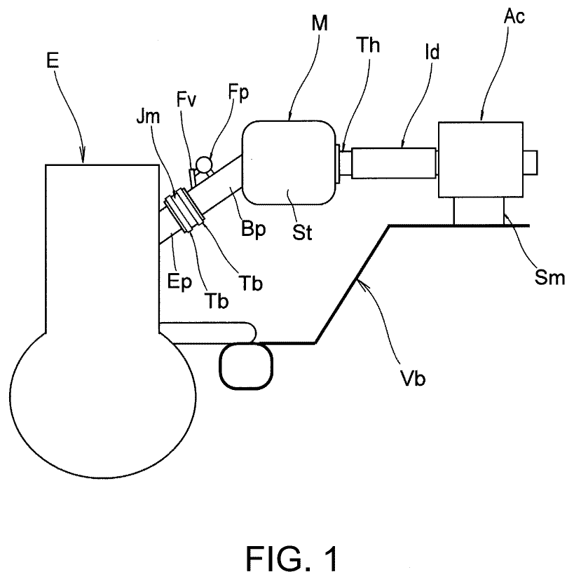

As shown in FIG. 1 to FIG. 3, the intake system includes: an intake manifold M; a fuel injection valve Fv, a feed pipe Fp, a throttle body Th, and a sensor unit Su detecting an intake air temperature, an intake air pressure, etc., which are attached to the intake manifold M; an intake duct Id connected to the throttle body Th; an air cleaner Ac connected to an upstream end of the intake duct Id; a support member Sm supporting the air cleaner Ac at a vehicle body Vb; a tubular joint member Jm connecting a tubular part Ep defining an intake port of the engine E and a tubular fitting part 120 of the intake manifold M; and fastening bands Tb.

Herein, the intake duct Id is formed of rubber or resin, which is lightweight and easily absorbs vibration, and may be formed to include a bellows part allowing elastic deformation. The air cleaner Ac includes, for example, a case made of resin having an inlet and an outlet, and a filter member disposed inside the case. The outlet is connected to an upstream end of the intake duct Id, and the inlet is connected to an outside air intake duct (not shown) as needed. The support member Sm supports (the case of) the air cleaner Ac with respect to the vehicle body Vb, and is a bracket provided at the vehicle body Vb or a bracket part (not shown) integrally formed with the air cleaner Ac and fastened and fixed to the vehicle body Vb by screws. The support member Sm may also be in a form that supports a part of the intake duct Id with respect to the vehicle body Vb.

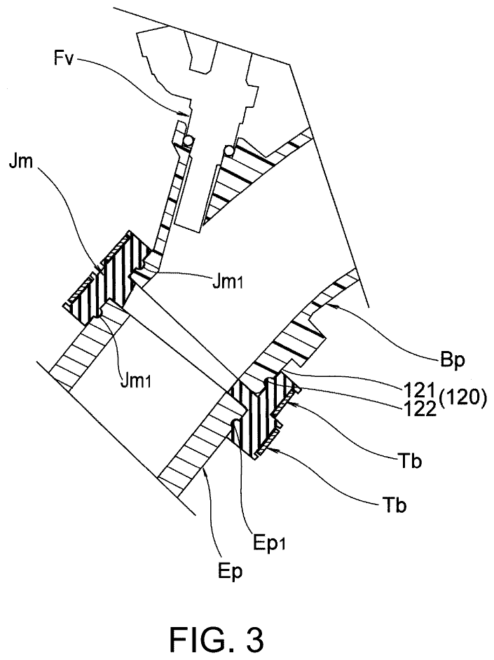

The tubular joint member Jm functions as a spigot joint, and is a joint member made of rubber having a ring-shaped cross-section molded using a rubber material absorbing vibration and capable of elastic deformation. In addition, as shown in FIG. 3, the tubular joint member Jm includes two annular protrusions Jm1 that are inserted into an annular groove 122 of the tubular fitting part 120 and an annular groove Ep1 of the tubular part Ep. The fastening band Tb is, for example, a band made of stainless steel having a fastening screw, and fastens around two fitting regions of the tubular joint member Jm in a state in which the tubular part Ep of the engine E fits into one end side of the tubular joint member Jm and the tubular fitting part 120 fits into the other end side of the tubular joint member Jm.

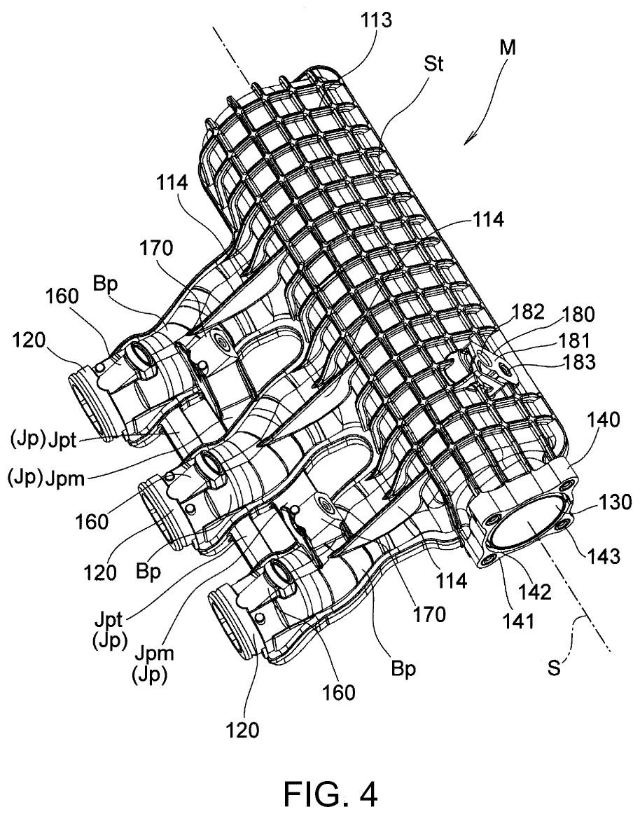

As shown in FIG. 4 to FIG. 12, the intake manifold M includes a base member 100 as a first molding member and a cover member 200 as a second molding member. The intake manifold M is composed of the base member 100 and the cover member 200 fixed by vibration welding, and as a whole, includes a surge tank St, multiple (herein, three) branch pipes Bp, and a linking part Jp that links the multiple branch pipes Bp to each other.

The surge tank St is formed in an elongated tubular shape along an axis S direction to define an internal space Is, with one end closed and the other end defining an inlet 130 and a flange part 140 to which the throttle body Th is attached.

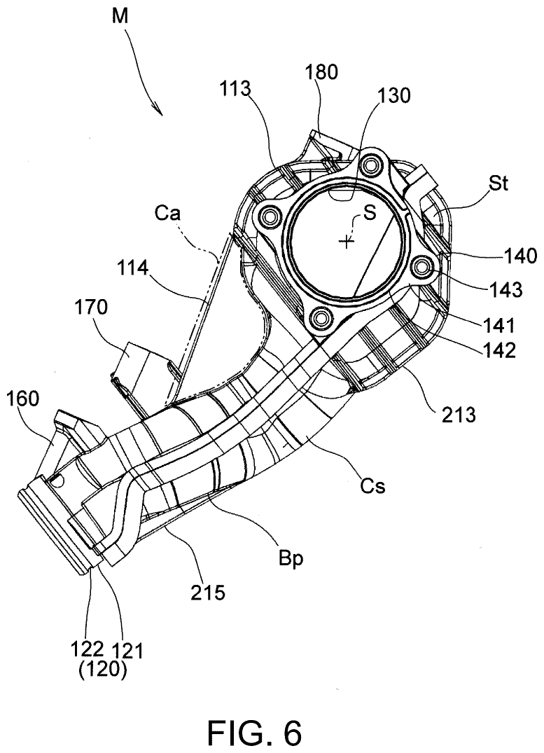

The multiple branch pipes Bp are integrally molded with the surge tank St, extend in a direction twisted with respect to the axis S, and are arranged along the axis S direction. As shown in FIG. 6, the branch pipe Bp is formed to include a tubular fitting part 120 in a tip region, and a curved part Cs that is curved from a base region to an intermediate region in a plane perpendicular to the axis S.

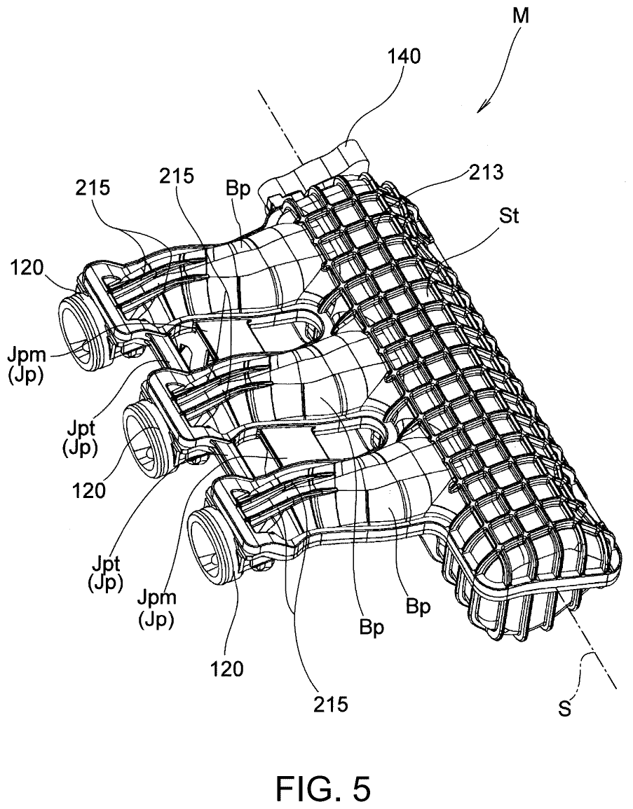

As shown in FIG. 4 and FIG. 5, the linking part Jp includes a tip-side linking part Jpt formed close to the downstream side of the branch pipe Bp, and an intermediate linking part Jpm formed in the intermediate region closer to the upstream side than the tip-side linking part Jpt.

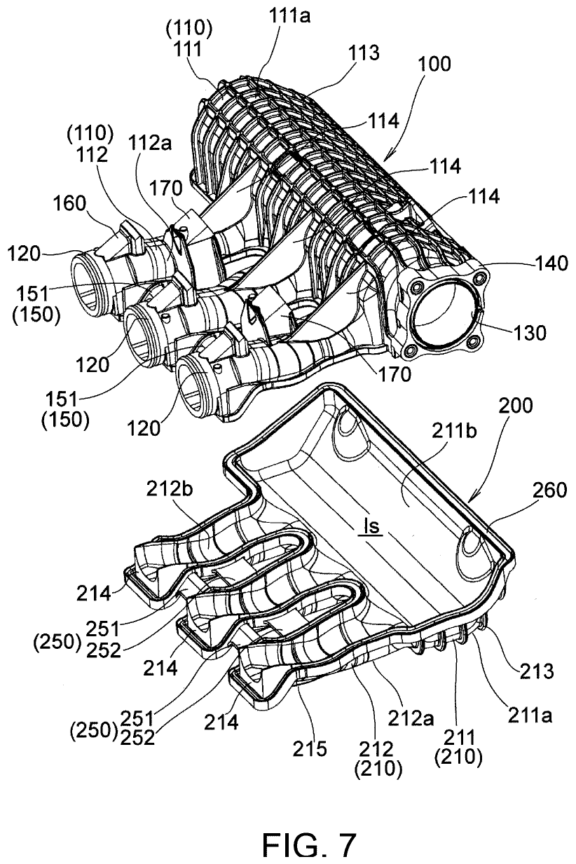

The base member 100 is injection molded with a mold using a resin material, and as shown in FIG. 7 to FIG. 9, includes a wall part 110 as a first half body of the surge tank St and the multiple branch pipes Bp, a tubular fitting part 120, an inlet 130, a flange part 140, a first linking part 150 (first tip-side linking part 151 and first intermediate linking part 152), an attachment part 160, two fixing parts 170, a flange part 180, and a joining part 190.

The wall part 110 includes a tank wall part 111 defining approximately half of the surge tank St, a branch wall part 112 defining approximately half of the multiple branch pipes Bp, a grid reinforcement rib 113 formed on an outer wall 111a of the tank wall part 111, and a first reinforcement rib 114 formed in the region of the curved part Cs.

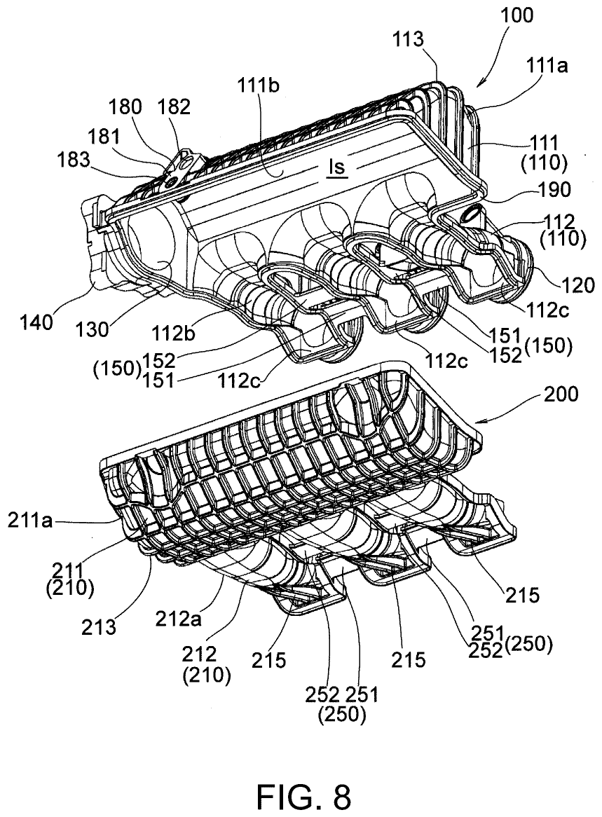

The tank wall part 111 is formed to define a recess forming an outer wall 111a and an inner wall 111b in an approximately semi-cylindrical shape elongated in the axis S direction. The branch wall part 112 has an outer wall 112a and an inner wall 112b to define approximately half of each of the three passages, and is formed to be curved while extending in a direction twisted with respect to the axis S. In addition, as shown in FIG. 8, the branch wall part 112 has a recessed joining part 112c to which a protruding joining part 214 of the cover member 200 is joined at the immediate upstream side of the tubular fitting part 120. The grid reinforcement rib 113 is formed to protrude in a grid pattern at a predetermined height from the outer wall 111a of the tank wall part 111 to enhance an overall bending strength of the surge tank St.

As shown in FIG. 4, FIG. 6, and FIG. 7, the first reinforcement rib 114 is formed to protrude in a thin plate shape from the outer walls 111a and 112a of the wall part 110 from a branching region, branching from the surge tank St, to the intermediate region. In addition, the first reinforcement rib 114 is formed to have an outline extending linearly from the outer wall 111a of the surge tank St (i.e., tank wall part 111) to the outer wall 112a of the branch pipe Bp (i.e., branch wall part 112) in a recess region Ca surrounded by the curved part Cs.

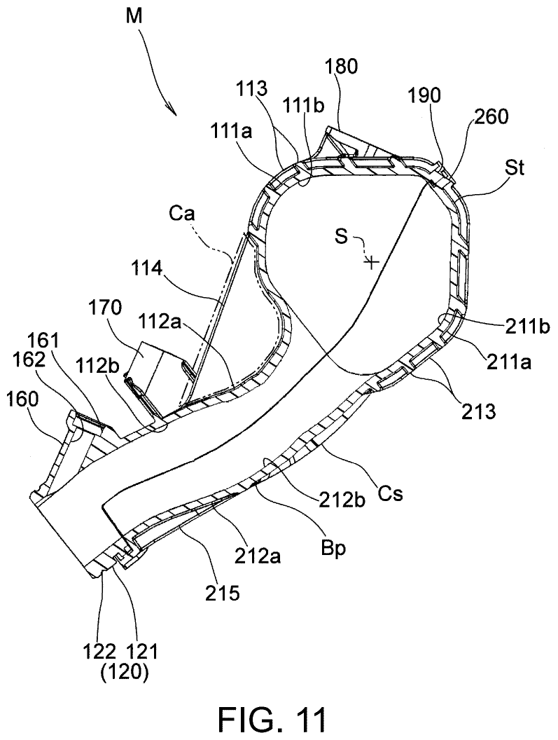

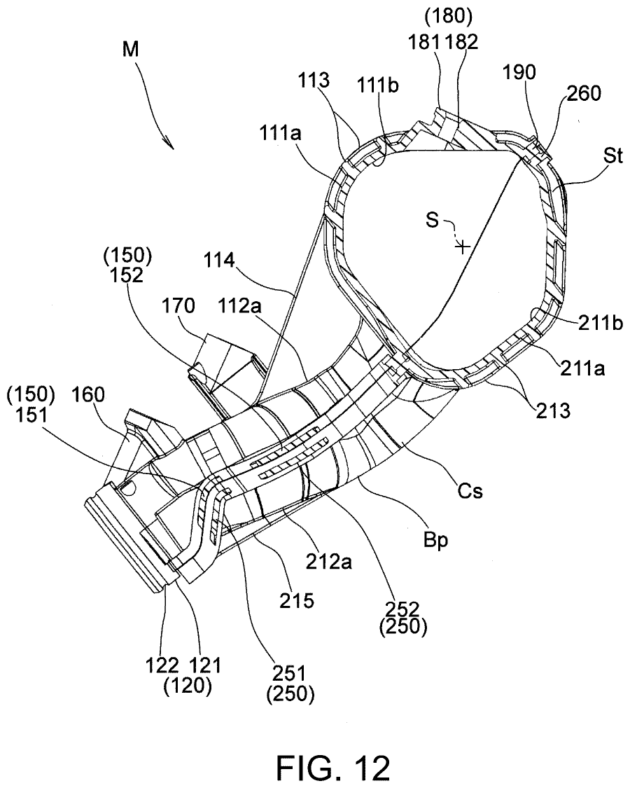

As shown in FIG. 6, FIG. 11, and FIG. 12, the tubular fitting part 120 is formed in a cylindrical shape at the tip region of the branch pipe Bp, and includes a fitting outer circumferential surface 121 and an annular groove 122 obtained by partially removing a part of the fitting outer circumferential surface 121. The fitting outer circumferential surface 121 is a region fitted into the tubular joint member Jm, and the annular groove 122 is a region into which the annular protrusion Jm1 of the tubular joint member Jm is inserted. In other words, the tubular fitting part 120 constitutes a spigot joint by being fitted into the other end side of the tubular joint member Jm, into which the tubular part Ep of the engine E is fitted on one end side.

The inlet 130 is formed as a circular opening at the other end in the axis S direction, and is a region introducing intake air, which has passed through the throttle body Th fixed to the flange part 140, into the internal space Is of the surge tank St. The flange part 140 is a region joining and fixing the throttle body Th, and as shown in FIG. 4 and FIG. 6, is formed around the inlet 130 at the other end in the axis S direction. The flange part 140 includes a joining surface 141, an annular groove 142 into which a seal member (not shown) is inserted, and four screw holes 143 for screwing in screws to fasten the throttle body Th.

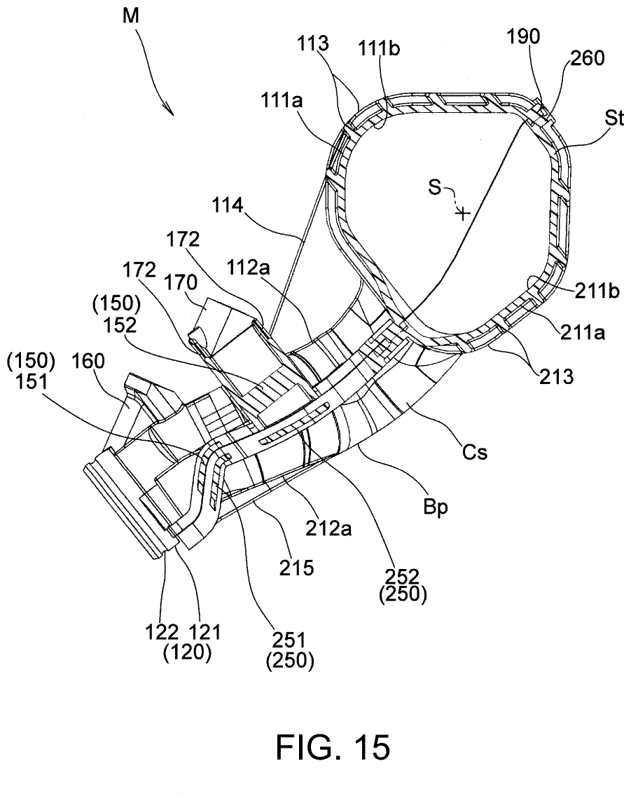

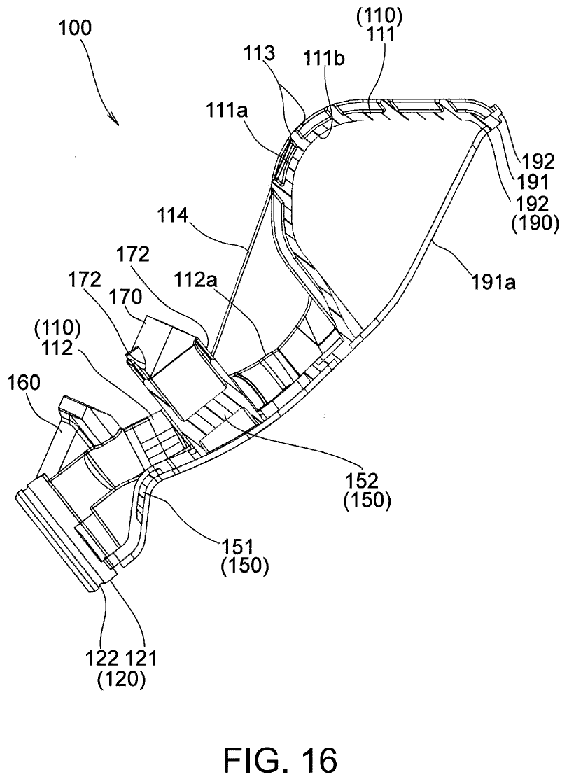

The first linking part 150 constitutes a part of the linking part Jp integrally molded to extend in the axis S direction to link the multiple branch pipes Bp to each other in a region separated from the tubular fitting part 120. As shown in FIG. 7 to FIG. 9, FIG. 12, FIG. 15, and FIG. 16, a first tip-side linking part 151 and a first intermediate linking part 152 are included as the first linking part. The first tip-side linking part 151 constitutes a part of the tip-side linking part Jpt. The first tip-side linking part 151 is formed to have a cross-section in a flat plate shape bent in an approximately inverted-V shape and extends in the axis S direction to link between the branch pipes Bp, at a position close to the downstream side of the branch pipes Bp and upstream of the tubular fitting part 120. The first intermediate linking part 152 constitutes a part of the intermediate linking part Jpm, and is formed to have a cross-section in an approximately rectangular flat plate shape and extend in the axis S direction to link between the branch pipes Bp, upstream of the first tip-side linking part 151.

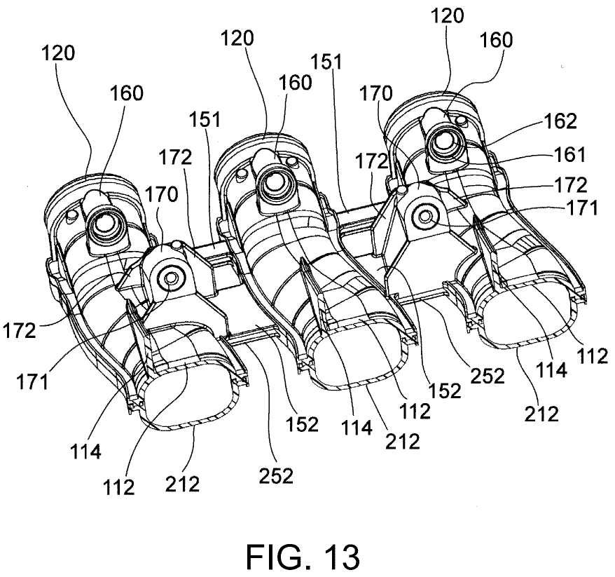

The attachment part 160 is a region to which the fuel injection valve Fv is attached, and as shown in FIG. 11 and FIG. 13, includes a fitting recess 161 and a through hole 162 at the immediate upstream side of the tubular fitting part 120. The fitting recess 161 is formed to fix a body of the fuel injection valve Fv by fitting or screwing. The through hole 162 is formed as an inclined hole inclined toward the downstream side such that fuel injected from the fuel injection valve Fv is injected toward the downstream side into the passage within the branch pipe Bp.

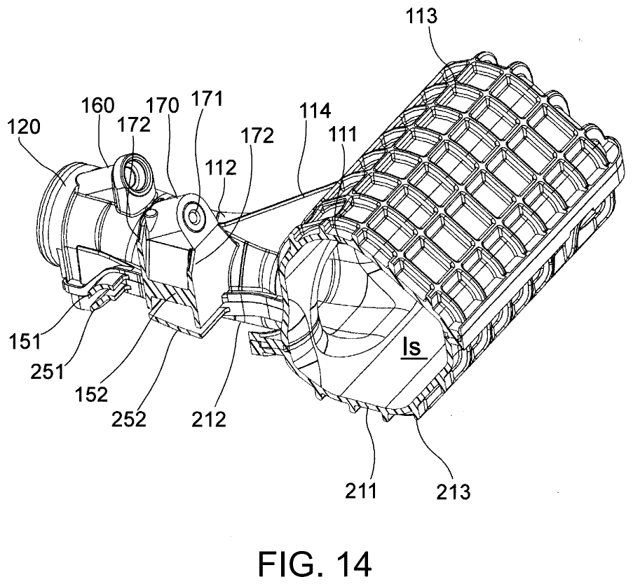

The two fixing parts 170 are regions fixing the feed pipe Fp. As shown in FIG. 13 to FIG. 15, the fixing part 170 is formed in the region of the intermediate linking part Jpm, i.e., the region of the first intermediate linking part 152, overlapping with two outer branch pipes Bp among the three branch pipes Bp arranged in the axis S direction, and includes a screw hole 171 for screwing in a screw to fasten a bracket (not shown) of the feed pipe Fp, and a reinforcement rib 172 extending to the first intermediate linking part 152 and the outer wall 112a.

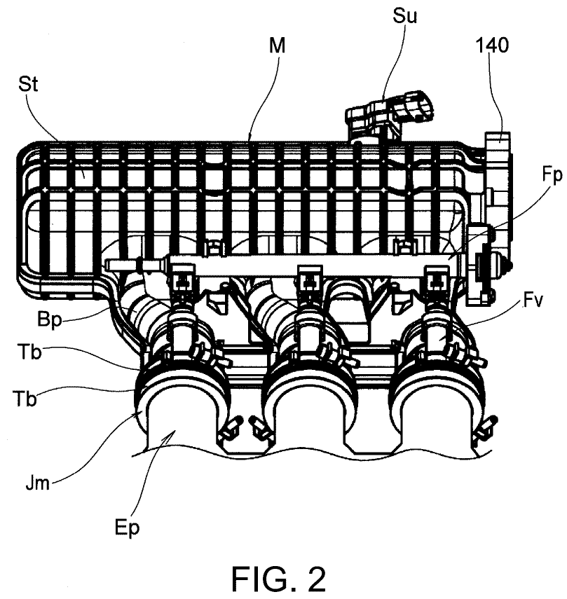

As shown in FIG. 2 and FIG. 4, the flange part 180 is a region for attaching the sensor unit Su, is formed at the tank wall part 111 of the surge tank St, and includes a joining surface 181 for joining the sensor unit Su, an insertion hole 182 for inserting a detection part (not shown) of the sensor unit Su, and a screw hole 183 for screwing in a screw to fasten the sensor unit Su.

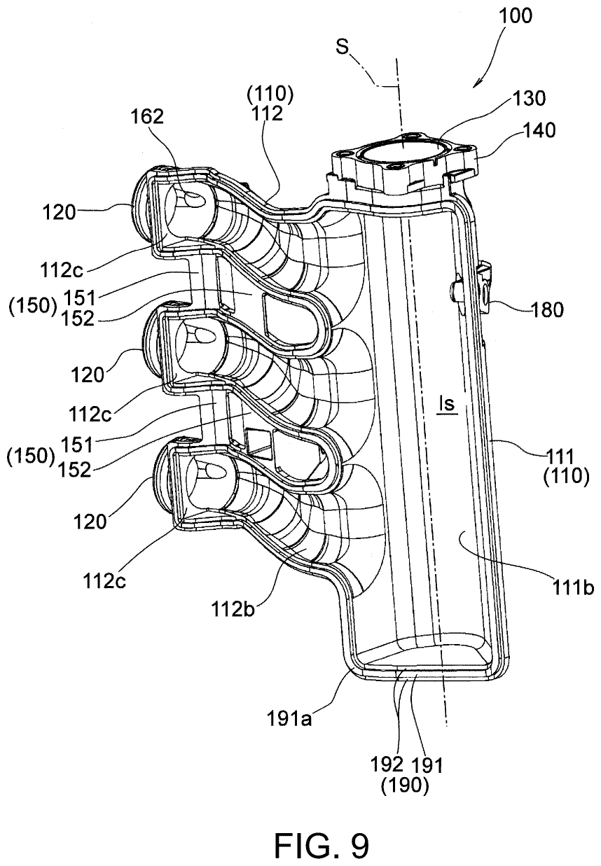

As shown in FIG. 9 and FIG. 16, the joining part 190 is a region that is fixed to a joining part 260 of the cover member 200 by vibration welding, and includes a ridge 191 having a rectangular cross-section and stepped down surfaces 192 formed on both sides of the ridge 191. In other words, at the joining part 190, a joining surface 191a of the ridge 191 is joined to a joining surface 261a of the joining part 260 of the cover member 200 and fixed by vibration welding.

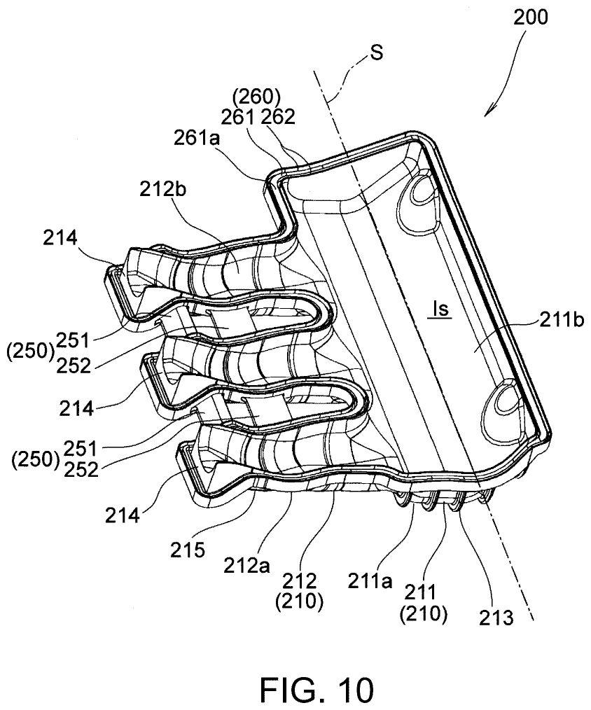

The cover member 200 is injection molded with a mold using a resin material, and as shown in FIG. 7, FIG. 8, and FIG. 10, includes a wall part 210 as a second half body of the surge tank St and the multiple branch pipes Bp, a second linking part 250 (second tip-side linking part 251 and second intermediate linking part 252), and a joining part 260.

The wall part 210 includes a tank wall part 211 defining approximately half of the surge tank St, a branch wall part 212 defining approximately half of the multiple branch pipes Bp, a grid reinforcement rib 213 formed on an outer wall 211a of the tank wall part 211, a protruding joining part 214, and a second reinforcement rib 215.

The tank wall part 211 is formed to define a recess forming an outer wall 211a and an inner wall 211b in an approximately cylindrical shape elongated in the axis S direction. The branch wall part 212 has an outer wall 212a and an inner wall 212b to define approximately half of each of the three passages, and is formed to be curved while extending in a direction twisted with respect to the axis S. The grid reinforcement rib 213 is formed to protrude in a grid pattern at a predetermined height from the outer wall 211a of the tank wall part 211 to enhance an overall bending strength of the surge tank St. The protruding joining part 214 is joined to the recessed joining part 112c of the base member 100 to define a passage having an approximately circular or elliptical cross-section as the passage of the branch pipe Bp.

As shown in FIG. 7 and FIG. 8, the second reinforcement rib 215 is formed to protrude in a plate shape from the outer wall 212a and extend toward the upstream side, upstream of the protruding joining part 214. In other words, the second reinforcement rib 215 is formed to protrude from the outer wall 212a on a side opposite to the recess region Ca surrounded by the curved part Cs and downstream of the curved part Cs, and extend toward the upstream side from the vicinity of the tubular fitting part 120, in a state in which the cover member 200 is joined to the base member 100.

The second linking part 250 constitutes a part of the linking part Jp integrally molded to extend in the axis S direction to link the multiple branch pipes Bp to each other in a region separated from the tubular fitting part 120. As shown in FIG. 7, FIG. 8, FIG. 10, FIG. 12, and FIG. 15, a second tip-side linking part 251 and a second intermediate linking part 252 are included as the second linking part. The second tip-side linking part 251 constitutes a part of the tip-side linking part Jpt. The second tip-side linking part 251 is formed to be opposed to the first tip-side linking part 151, have a cross-section in a flat plate-shape bent in an approximately inverted-V shape, and extend in the axis S direction to link between the branch pipes Bp, at a position close to the downstream side of the branch pipe Bp and upstream of the tubular fitting part 120. The second intermediate linking part 252 constitutes a part of the intermediate linking part Jpm, and is formed to be opposed to the first intermediate linking part 152, have a cross-section in an approximately rectangular flat plate shape, and extend in the axis S direction to link between the branch pipes Bp, upstream of the second tip-side linking part 251.

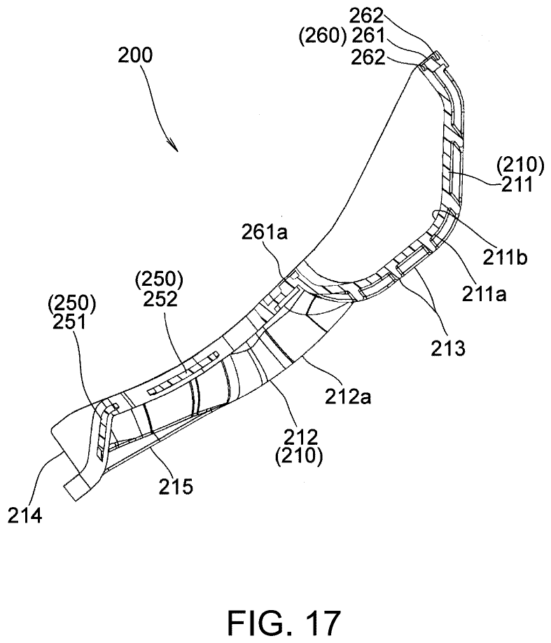

As shown in FIG. 10 and FIG. 17, the joining part 260 is a region that is fixed to the joining part 190 of the base member 100 by vibration welding, and includes a ridge 261 having a rectangular cross-section and recessed strips 262 formed on both sides of the ridge 261. In other words, at the joining part 260, the joining surface 261a of the ridge 261 is joined to the joining surface 191a of the joining part 190 of the base member 100 and fixed by vibration welding.

Next, an assembling work of the intake system including the intake manifold M with the above configuration will be described. The intake manifold M, three fuel injection valves Fv, the feed pipe Fp, the throttle body Th, three tubular joint members Jm, six fastening bands Tb, the intake duct Id, and multiple screws (not shown) are prepared in advance.

First, the air cleaner Ac is fixed to the vehicle body Vb via the support member Sm provided at the vehicle body Vb. In addition, in the intake manifold M, the fuel injection valves Fv are attached to the attachment parts 160, the feed pipe Fp is connected to the fuel injection valves Fv and fixed to the fixing parts 170, and the throttle body Th is fixed to the flange part 140.

Next, the intake manifold M with various components assembled is connected to the tubular part Ep defining the intake port of the engine E. Specifically, the tubular part Ep is fitted into one end side of the tubular joint member Jm, and the tubular fitting part 120 of the intake manifold M is fitted into the other end side of the tubular joint member Jm. Then, the periphery of the fitting region of the tubular joint member Jm is fastened by the fastening band Tb.

Next, the intake duct Id is disposed between the throttle body Th and the air cleaner Ac, with the downstream end of the intake duct Id connected to the throttle body Th and the upstream end of the intake duct Id connected to the air cleaner Ac. The fitting region of the intake duct Id may be fastened with a fastening band as needed. The assembling procedure is not limited to the above method, and assembly may also be performed according to other procedures.

Accordingly, in the configuration in which the intake manifold M is connected to the tubular part Ep of the engine E by a spigot joint, the assembling work is simplified since the intake manifold M integrally includes the surge tank St and the multiple branch pipes Bp.

The intake manifold M with the above configuration includes: a surge tank St that defines an internal space Is temporarily storing intake air, an inlet 130, and a flange part 140 fixing a throttle body Th around the inlet 130; multiple branch pipes Bp that are integrally molded with the surge tank St and include tubular fitting parts 120 at respective tip regions; and a linking part Jp integrally molded with the multiple branch pipes Bp to link the multiple branch pipes Bp to each other upstream of the tubular fitting parts 120. Accordingly, the multiple branch pipes Bp having tubular fitting parts 120 independent of each other are integrally molded with the surge tank St, and the linking part Jp linking the multiple branch pipes Bp to each other is included. Thus, relative positional relationships (e.g., relative separation distances) between the multiple branch pipes Bp can be maintained with high accuracy while ensuring a mechanical strength, and simplification of the structure, reduction in the number of components, cost reduction, etc. can be achieved.

In addition, upstream of the tubular fitting parts 120, the multiple branch pipes Bp include attachment parts 160 to which fuel injection valves Fv are respectively attached, and at least two fixing parts 170 fixing a feed pipe Fp that feeds fuel to the fuel injection valves Fv. Accordingly, in the region of the multiple branch pipes Bp reinforced by the linking part Jp, the fuel injection valves Fv can be attached to the attachment parts 160, and the feed pipe Fp can be attached to the fixing parts 170. Thus, a firm assembly of the fuel injection valves Fv and the feed pipe Fp can be achieved. In particular, by forming the fixing parts 170 for fixing the feed pipe Fp in the region of the linking part Jp, the assembly of the feed pipe Fp can be performed more firmly.

In addition, the linking part Jp includes a tip-side linking part Jpt formed close to a downstream side of the branch pipe Bp, and an intermediate linking part Jpm formed in an intermediate region closer to an upstream side than the tip-side linking part Jpt. Accordingly, a mechanical strength of a required region can be enhanced while achieving weight reduction. In particular, by forming the fixing parts 170 for fixing the feed pipe Fp in the region of the intermediate linking part Jpm, an overall mechanical strength can be enhanced while achieving weight reduction to perform the assembly of the feed pipe Fp more firmly.

In addition, the multiple branch pipes Bp each include a first reinforcement rib 114 formed protruding from outer walls 111a and 112a from a branching region, branching from the surge tank St, to the intermediate region. Accordingly, a mechanical strength in a base region of the branch pipe Bp can be enhanced, warpage of the branch pipe Bp with respect to the surge tank St can be prevented, and vibration resistance can be enhanced.

The surge tank St is formed to be elongated in a direction of a predetermined axis S, and the multiple branch pipes Bp are formed to extend in a direction twisted with respect to the axis S and include a curved part Cs that is curved in a plane perpendicular to the axis S. The first reinforcement rib 114 is formed to have an outline that extends linearly from the outer wall 111a of the surge tank St to the outer wall 112a of the branch pipe Bp in a recess region Ca surrounded by the curved part Cs. Accordingly, since the first reinforcement rib 114 is formed to have a linear outline in the recess region Ca surrounded by the curved part Cs, the mechanical strength is further enhanced, warpage or deformation of the branch pipe Bp can be reliably prevented, and vibration resistance can be further enhanced.

In addition, the multiple branch pipes Bp include a second reinforcement rib 215 that protrudes from the outer wall 112a on a side opposite to a side formed with the recess region Ca and downstream of the curved part Cs, and extends from the vicinity of the tubular fitting part 120 toward an upstream side. Accordingly, warpage or deformation of the branch pipe Bp can be prevented in a range from the tip region to the intermediate region of the branch pipe Bp, and vibration resistance can be enhanced.

In addition, since the surge tank St includes grid reinforcement ribs 113 and 213 integrally molded on the outer wall thereof, i.e., on the outer walls 111a and 211a of the tank wall parts 111 and 211, the mechanical strength of the surge tank St can be enhanced.

In addition, the intake manifold M with the above configuration includes: a first molding member (base member 100) defining a first half body (wall part 110) of the surge tank St and the multiple branch pipes Bp, the tubular fitting parts 120, the inlet 130, and the flange part 140; and a second molding member (cover member 200) defining a second half body (wall part 210) of the surge tank St and the multiple branch pipes Bp and joined to the first molding member (base member 100). Accordingly, with the two-part structure, the intake manifold M can be easily molded using a resin material while achieving reduction in the number of components.

In particular, the first molding member (base member 100) includes a first tip-side linking part 151 forming a part of the tip-side linking part Jpt, a first intermediate linking part 152 forming a part of the intermediate linking part Jpm, the attachment parts 160, and the fixing parts 170. The second molding member (cover member 200) includes a second tip-side linking part 251 forming a part of the tip-side linking part Jpt, and a second intermediate linking part 252 forming a part of the intermediate linking part Jpm. Accordingly, after molding of the first molding member (base member 100), warping of branch wall parts 112 defining the multiple branch pipes Bp or relative misalignment of the multiple branch wall parts 112 can be prevented by the first tip-side linking part 151 and the first intermediate linking part 152. In addition, after molding of the second molding member (cover member 200), warpage of branch wall parts 212 defining the multiple branch pipes Bp or relative misalignment of the multiple branch wall parts 212 can be prevented by the second tip-side linking part 251 and the second intermediate linking part 252. As a result, when joining the first molding member (base member 100) and the second molding member (cover member 200) and fixing by vibration welding, a high-precision intake manifold M with desired dimensions and positional relationships can be obtained.

In addition, the intake system with the above configuration includes the intake manifold M, fuel injection valves Fv attached to the attachment parts 160, a feed pipe Fp fixed to the fixing parts 170, and a throttle body Th fixed to the flange part 140. Accordingly, by pre-assembling the fuel injection valves Fv, the feed pipe Fp, and the throttle body Th to the intake manifold M, in which the surge tank St and the multiple branch pipes Bp are integrally molded into a single unit, the intake system can be handled as one module, and the overall assembling work of the intake system can be simplified.

In addition, by including a tubular joint member Jm made of rubber, into one end side of which a tubular part Ep defining an intake port of an engine E fits and into the other end side of which the tubular fitting part 120 of the intake manifold M fits, vibration transmitted from the engine E to the intake manifold M can be absorbed or blocked to suppress or prevent vibration of the intake manifold M. In particular, by including a fastening band Tb fastening around a fitting region of the tubular joint member Jm, loosening of the fitting region can be reliably prevented.

In addition, the intake system includes an intake duct Id connected to the throttle body Th and an air cleaner Ac connected to an upstream end of the intake duct Id, and by including a support member Sm that supports the intake duct Id or the air cleaner Ac with respect to a vehicle body Vb on which the engine E is mounted, vibration of the intake manifold M can be suppressed or prevented while holding the intake manifold M.

The above embodiment has illustrated a configuration including the tip-side linking part Jpt formed close to the downstream side of the branch pipes Bp and the intermediate linking part Jpm formed in the intermediate region closer to the upstream side than the tip-side linking part Jpt, as linking parts integrally molded with the multiple branch pipes Bp to link the multiple branch pipes Bp to each other upstream of the tubular fitting parts 120. However, the embodiment is not limited thereto, and may also adopt a configuration in which one linking part is integrally molded to link the multiple branch pipes Bp to each other.

The above embodiment has illustrated a configuration in which the first molding member (base member 100) includes two linking parts (first tip-side linking part 151 and first intermediate linking part 152) as the first linking part 150, and the second molding member (cover member 200) includes two linking parts (second tip-side linking part 251 and second intermediate linking part 252) as the second linking part 250. However, the embodiment is not limited thereto, and may also adopt a configuration in which the first molding member includes one first linking part and the second molding member includes one second linking part.

In the above embodiment, two fixing parts 170 have been illustrated as fixing parts fixing the feed pipe Fp. However, the embodiment is not limited thereto, and may also adopt three fixing parts, or may also adopt four or more fixing parts in response to an increase in the number of the branch pipes Bp.

In the above embodiment, the inlet 130 and the flange part 140 provided on the other end side of the surge tank St in the axis S direction have been illustrated as the inlet and the flange part formed around the inlet. However, the embodiment is not limited thereto, and may also adopt a configuration in which an inlet opened in a direction intersecting the axis S and a flange part around the inlet are provided at approximately the center of the surge tank St.

The above embodiment has illustrated the intake manifold M with a two-part structure composed of the first molding member (base member 100) and the second molding member (cover member 200). However, the embodiment is not limited thereto, and may also adopt a configuration in another division form.

In the above embodiment, the intake manifold M including three branch pipes Bp to be applied to a three-cylinder engine has been illustrated as the intake manifold. However, the embodiment is not limited thereto, and the intake manifold may also be formed with two or four or more branch pipes to be applied to an engine with two cylinders or four or more cylinders.

As described above, according to the intake manifold and the intake system of the disclosure, simplification of the structure, reduction in the number of components, simplification of the assembling work, cost reduction, etc. can be achieved while ensuring the mechanical strength. Thus, the intake manifold and the intake system of the disclosure can be applied not only to engines mounted on vehicles such as ROVs and UTVs that travel in rough road environments, but are also useful as an intake manifold and an intake system of engines mounted on other vehicles.

What is claimed is:

1. An intake manifold, made of resin applied to an engine, comprising:
a surge tank that defines an internal space temporarily storing intake air, an inlet, and a flange part configured to fix a throttle body around the inlet;
a plurality of branch pipes that are integrally molded with the surge tank and comprise tubular fitting parts at respective tip regions; and
a linking part integrally molded with the plurality of branch pipes to link the plurality of branch pipes to each other upstream of the tubular fitting parts.

2. The intake manifold according to claim 1, wherein
upstream of the tubular fitting parts, the plurality of branch pipes comprise attachment parts to which fuel injection valves are to be respectively attached, and at least two fixing parts configured to fix a feed pipe that feeds fuel to the fuel injection valves.

3. The intake manifold according to claim 2, wherein
each of the fixing parts is formed in a region of the linking part.

4. The intake manifold according to claim 2, wherein
the linking part comprises a tip-side linking part formed close to a downstream side of the branch pipe, and an intermediate linking part formed in an intermediate region closer to an upstream side than the tip-side linking part.

5. The intake manifold according to claim 4, wherein
each of the fixing parts is formed in a region of the intermediate linking part.

6. The intake manifold according to claim 1, wherein
the plurality of branch pipes each comprise a first reinforcement rib formed protruding from an outer wall from a branching region, branching from the surge tank, to an intermediate region.

7. The intake manifold according to claim 6, wherein
the surge tank is formed to be elongated in a direction of a predetermined axis,
the plurality of branch pipes are formed to extend in a direction twisted with respect to the axis and comprise a curved part that is curved in a plane perpendicular to the axis, and
the first reinforcement rib is formed to have an outline that extends linearly from an outer wall of the surge tank to an outer wall of the branch pipe in a recess region surrounded by the curved part.

8. The intake manifold according to claim 7, wherein
the plurality of branch pipes comprise a second reinforcement rib that protrudes from the outer wall on a side opposite to a side formed with the recess region and downstream of the curved part, and extends from the vicinity of the tubular fitting part toward an upstream side.

9. The intake manifold according to claim 1, wherein
the surge tank comprises a grid reinforcement rib integrally molded on an outer wall of the surge tank.

10. The intake manifold according to claim 1, comprising:
a first molding member defining a first half body of the surge tank and the plurality of branch pipes, the tubular fitting parts, the inlet, and the flange part; and
a second molding member defining a second half body of the surge tank and the plurality of branch pipes and joined to the first molding member.

11. The intake manifold according to claim 2, comprising:
a first molding member defining a first half body of the surge tank and the plurality of branch pipes, the tubular fitting parts, the inlet, and the flange part; and
a second molding member defining a second half body of the surge tank and the plurality of branch pipes and joined to the first molding member, wherein
the first molding member comprises a first linking part forming a part of the linking part, the attachment parts, and the fixing parts, and
the second molding member comprises a second linking part forming a part of the linking part.

12. The intake manifold according to claim 4, comprising:
a first molding member defining a first half body of the surge tank and the plurality of branch pipes, the tubular fitting parts, the inlet, and the flange part; and
a second molding member defining a second half body of the surge tank and the plurality of branch pipes and joined to the first molding member, wherein
the first molding member comprises a first tip-side linking part forming a part of the tip-side linking part, a first intermediate linking part forming a part of the intermediate linking part, the attachment parts, and the fixing parts, and
the second molding member comprises a second tip-side linking part forming a part of the tip-side linking part, and a second intermediate linking part forming a part of the intermediate linking part.

13. An intake system comprising:
an intake manifold made of resin applied to an engine, the intake manifold comprising:
a surge tank that defines an internal space temporarily storing intake air, an inlet, and a flange part configured to fix a throttle body around the inlet;
a plurality of branch pipes that are integrally molded with the surge tank and comprise tubular fitting parts at respective tip regions; and
a linking part integrally molded with the plurality of branch pipes to link the plurality of branch pipes to each other upstream of the tubular fitting parts, wherein
upstream of the tubular fitting parts, the plurality of branch pipes comprise attachment parts to which fuel injection valves are to be respectively attached, and at least two fixing parts configured to fix a feed pipe that feeds fuel to the fuel injection valves;
the fuel injection valves attached to the attachment parts;
the feed pipe fixed to the fixing parts; and
the throttle body fixed to the flange part.

14. The intake system according to claim 13, comprising:
a tubular joint member made of rubber, into one end side of which a tubular part defining an intake port of an engine fits and into another end side of which the tubular fitting part of the intake manifold fits.

15. The intake system according to claim 14, comprising:
a fastening band fastening around a fitting region of the tubular joint member.

16. The intake system according to claim 15, comprising:
an intake duct connected to the throttle body; and
an air cleaner connected to an upstream end of the intake duct.

17. The intake system according to claim 16, comprising:
10 a support member supporting the intake duct or the air cleaner with respect to a vehicle body on which the engine is mounted.
